(19) United States
(12) Patent Application Publication
(10) Pub. No.: US 2008/0244217 A1
(43) Pub. Date: Oct. 2, 2008

(54) SAFETY MODULE FOR A FRANKING MACHINE

(76) Inventors: Volker Baum, Berlin (DE); Dirk Rosenau, Berlin (DE)

Correspondence Address: SCHIFF HARDIN, LLP;PATENT DEPARTMENT, 6600 SEARS TOWER, CHICAGO, IL, 60606-6473, US

(21) Appl. No.: 12/056,628

(22) Filed: Mar. 27, 2008

(30) Foreign Application Priority Data
Apr. 2, 2007 (DE) 10 2007 016 170.2

(51) Int. Cl. G06F 12/06

(52) U.S. Cl. 711/173; 711/E12.084

(57) ABSTRACT

The invention relates to a safety module for the electronic data processing, with a safety core comprising a core processor, and connected therewith, a core memory and a core interface, the core processor being adapted to import via the core interface, to verify and with successful verification to store and to activate programs/data sets in the core memory. It is characterized by that the safety core is connected by the core interface with a mass storage of the safety module arranged outside of the safety core, wherein the memory capacity of the mass storage is a multiple of the memory capacity of the core memory, that the core processor is adapted to import, verify and activate programs/data sets loaded into the mass storage for a program execution in a partitioned manner in the core memory, and that the core processor is adapted to authenticate partitioned programs/data sets not required for the program execution and stored in the core memory and to export them into the mass storage and/or to delete them in the core memory.

### BACKGROUND OF THE INVENTION

1. Field of the Invention

The invention relates to a safety module for the electronic data processing, of the type having a safety core with a core processor, and connected therewith, a core memory and a core interface, the core processor being adapted to import via the core interface, to verify and with successful verification to store and to activate programs/data sets in the core memory. The invention further relates to a method for operating such a safety module and to the use of such a safety module in a franking machine.

2. Prior Art and Background of the Invention

Franking machines and computers with a franking function typically include a printer for printing a postage stamp on a mailpiece, a control unit for controlling the printer, an input unit for manual or electronic input of money values of the postage stamp and a calculation unit for calculating spent money values and for calculating the remaining balances, the mail rate data. Mail rate data, at least parts of the program of the calculation unit, and keys and/or authentication codes used by the calculation unit are sensitive data, which must be protected from the access (reading, changing) of unauthorized persons. Safety modules in franking machines are also called Postal Security Devices (PSDs). An example is described in the document EP 0 789 333 A2.

For the purpose of this protection, a so-called safety module is provided in the calculation unit, this safety module comprising an electronic circuitry with the components described above. Safety-relevant data, for instance cryptographic key codes, are stored in the core memory and/or key memory. In the core memory are further stored firmware for the core processor and safety-relevant and non-safety-relevant data. The circuitry is further provided with means for the detection of unauthorized manipulations, for which purpose serve for instance and not necessarily exclusively means for monitoring temperature and voltage, safety contacts and safety envelopes. The means for the detection are normally connected with an auxiliary energy source, which secures a function even without the main energy source of the safety module. If for instance temperature and/or voltage are outside of a given operating range, the means for the detection will terminate the operation of the safety module in total, at least temporarily. If the means for the detection detect an unauthorized mechanical interference, the operation of the safety module is normally immediately and permanently terminated, and at least the keys in the key memory are deleted. A structural embodiment of means for the detection of an unauthorized interference is for instance described in the document EP 0 417 447 A2.

Safety modules are further employed for instance in automatic teller machines, ticket machines, cash registers, cash systems, electronic purses, computers, such as PCs, notebooks, palmtops, mobile telephone devices (cellular phones), and devices, which comprise several such functionalities, if applicable also of a franking machine.

Due to the numerous applications, as exemplarily mentioned above, safety modules are normally limited to basic functions. These are amongst others: access authorization for the administration and use of a software (e.g. by means of passwords or PINS), key generation and storage, key use (data authentication, verification, encryption and decryption), key import and export.

Safety modules can be adapted as multi-chip modules (MCMs), but also as single-chip modules (SCMs).

Evaluated safety modules contain a test certificate, which documents the version of the hardware and firmware and thus confirms the safety for the respective version. When the current version is modified, the certificate becomes obsolete and a new certification is required. An example for an evaluation standard is FIPS 140.

PSDs are cryptographic hardware safety modules, which are specifically employed for the postal application of franking. PSDs have many functions of conventional safety modules, are however extended by postally relevant functions, such as safe writing and storing of money values, safe processing of data for the aftestable calculation of money values, safe re-loading of money value balances, and methods for verifying the plausibility of the data stocks.

Therefore, safety modules have been developed, which with the aid of a basic firmware existing in all safety modules can load, authenticate and execute further firmware, which is for instance application-dependent and/or country-dependent. Thereby it is achieved that for instance for different countries, the same safety module can be used for the production of a franking machine, which safety module is then later adapted with regard to the firmware to the intended application. An example is described in the document DE 101 37 505 B4. An example for a method for loading data/firmware is given in the document DE 10 2004 063 812 A1.

The basic firmware employed for safety modules are normally most simple, not concurrent systems, which further do not require an operating system. Thereby, the efforts for documentation and evaluation of the source codes are low. Using a multi-threading operating system and executing non-evaluated firmware by the module is in principle possible and also evaluable, the evaluation efforts and thus the related costs would however be relatively very high. Thus, a safety module, which is to execute evaluated as well as not evaluated firmware, needs to fulfill special requirements for obtaining its certification. Thereto and consequently also to the evaluation belong the separation of the evaluated and not evaluated operational mode and routines, which make it impossible for a not evaluated firmware to access to data or operating means of the evaluated firmware.

For safety modules, on one hand the trend is found to increase the integration of the hardware. Thereby, costs are reduced, but also the safety is increased, for instance against contacting attempts or analysis of the current consumption or radiation behavior. Further, by a lower current consumption, the life of often required auxiliary energy sources is increased. On the other hand there is the requirement of increasing the variability and functionality of the firmware. The result is a growth of the program code and of the data base of the firmware. The latter will even lead to problems, since this contradicts the requirement of a higher integration. Single-chip computers with suitable periphery, mathematic long-number assistance, sensors and controllers for actors are available, however the integrated random access memories (RAMs) and read only memories (ROM) or flash memories have capacities, which are not sufficient for the extended functionalities.

### SUMMARY OF THE INVENTION

It is an object of the invention to provide a safety module, which has sufficient memory capacities for extended functionalities, while still offering a high safety with unchanged low efforts for the design and for the evaluation or certification.

The following definitions apply to terms used herein.

A safety core is a structural sector, which includes a circuitry or a part of circuitry, the circuitry being provided with means for the prevention and/or detection of unauthorized manipulations, such as reading attempts, contacting attempts, etc. Among such items are envelopes, potting material, mechanical sensors, temperature sensors, current sensors, voltage sensors, etc. An envelope is practically always provided and a safety core is thus a monolithic structural unit. In the safety core are arranged core processor, core memory and core interface and if applicable further components of the circuitry.

A safety module has a safety core and a safety core-external mass storage, which is connected by a core interface with a core processor. The mass storage can be located immediately at the safety core and form a structural unit therewith. It is however also possible that the mass storage is spatially separated from the safety core and connected therewith by a data line (e.g. USB, UART, PCI) or even remote data transfer (e.g. ethernet).

A mass storage is a memory, wherein a higher quantity of data can be stored than in the core memory. A multiple is at least double, however also has up to 10 times, 100 times, or more.

Programs normally include, beside the actual program code also data sets. Data sets do not necessarily from a program code.

Partitioned programs/data sets are separated into different partial program parts/data set parts. For example, programs can be partitioned into different flow steps. A regularly required subroutine may also form a partial program part. A partial program part needs not necessarily have a closed functionality. Data sets can in principle be partitioned in an arbitrary manner, and different data required close to the flow by a program code suitably form a partial data set part.

An authentication includes the data connection of a program/data set with an authentication code. This is individual for the respective program or the respective data set, since it is formed from the contents thereof, for the formation a given key code being applied.

A verification typically includes the examination of an authenticated program/data set by means of a key code for matching with regard to the authentication code. If the authentication code of a program/data set provided with the authentication code is submitted to an operation inverse to the authentication by means of the same key, from the match of the authentication code of the program and of a stored authentication code the authenticity can be determined and thus the program/data set can be verified. Known authentication codes include for instance the message authentication code (MAC), e.g. based on the AES algorithm.

An encryption includes a transformation of a program/data set by means of a key code. After encryption, a program/data set cannot be used. For using it, a decryption by means of the key code or a different decryption code correlated herewith is necessary, and the transformation is reversed. A key code for the encryption or decryption may for instance be a public key, e.g. with a PKI certificate.

A hash value is an in most cases natural number, which is determined from a data string or character string as source data by means of a hash function and has a (clearly) smaller size than the source data. Basically, this is a data reduction, and a unique assignment of hash value and source data is not possible, but a comparison of the hash values of source data with identity of the hash value means with a high probability the identity of the source data. In the cryptologic sector, ideally the possibilities of so-called collisions (probability of different source data with identical hash value) are reduced or excluded. An inverse calculation (source data from the hash value) is not possible in an efficient manner. Examples for hash functions are: division-remainder method, double-hashing, multiplicative method, mid-square method, dissection method, figure analysis, crossfoot sum. Examples for hash algorithms are: Adler-32, hash table, Merkle's meta method, modulo method, parity, checksum, check digit, crossfoot sum, salted hash, cyclic redundancy test, MD2, MD4, MD5, SHA, RIPEMD-160, TIGER, HAVAL, whirlpool.

A key memory is a memory sector, optionally separated from the core memory, however arranged within the safety core, in which cryptographic key codes and/or authentication codes are permanently stored. An unauthorized modification of the memory contents of a key memory is not possible, only the cancellation thereof, for instance in response on an unauthorized access to the safety core.

A memory management unit (MMU) serves for the translation of a requested virtual (logic) address into a physical (memory) address. An MMU typically comprises a translation lookaside buffer (TLB) in most cases adapted as a cache memory, which stores the respectively last address translations in the form of a table. The types of address translation are distinguished by the types of the used side tables, a physical address needs not necessarily be assigned to a logic address. If such an address is touched upon, a so-called side error (exception) occurs, and the firmware loads a program file or data file stored in the mass storage and thus exported from the safety core in the manner described in detail in the description.

A cache memory is a buffer memory, in which copies of data of another memory are temporarily included, thus the access to the data being accelerated.

Firmware is so-called hardware-close software, which includes the elementary functions for the control of the core processor and thus of the safety module, including input and output routines. In the meaning of the invention, authentication and/or verification routines and encryption and decryption routines also belong thereto. Firmware is always stored in the safety core, and permanently that is. It cannot easily be changed. In contrast thereto, programs/data sets for the program execution are subordinate and represent the actual software.

Sections are program or data portions, which are combined by a linker. Program code sections comprise CODE or TEXT as an executable program, and if applicable INIT and FINI as an initialization part or a finalization part of the executable program. Data code sections DATA, RODATA, or BSS comprise data of the program. The data of a DATA section can be changed for the duration of the program (also called volatile data). The data of a RODATA section cannot be modified (read only, also called non-volatile or persistent data). The data of a BSS section contain zero-initialized data.

Compressed data are data sets, the extent of which is reduced by means of a compression algorithm, i.e. require less memory space than the correlated, not compressed data. Compressed data are decompressed with a decompression algorithm being inverse to the compression algorithm, i.e. the original data set is re-established. Compression and decompression algorithms are well known to the man skilled in the art and therefore do not need any further explanation.

Safety-critical data are data, the change and/or readout of which by unauthorized access must be prevented. An example of safety-critical data are data for money values, in particular money value balances.

Basics of the invention and preferred embodiments.

The invention is characterized by that the safety core being connected by the core interface with a mass storage of the safety module arranged outside of the safety core, wherein the memory capacity of the mass storage is a multiple of the memory capacity of the core memory, and the core processor is adapted to import, verify and activate programs/data sets loaded into the mass storage for a program execution in a partitioned manner in the core memory, and the core processor is adapted to export partitioned programs/data sets not required for the program execution and stored in the core memory into the mass storage after authentication and/or to delete them in the core memory.

It is achieved by the invention that the core memory is only loaded with memory contents, which are required for the program execution at this instant, while memory contents not required at this instant are newly occupied with required memory contents, if memory capacity is required. The memory contents stored in the core memory have always been verified by the firmware in the safety core. As a result, programs can be executed in the safety core and under the evaluated conditions of safety, while the complete memory demand of the program is substantially higher than the capacity of the core memory. Furthermore, with unmodified safety core and firmware included therein, different program versions can be stored in the mass storage and executed (in a verified manner), so that the safety module needs not be again or separately evaluated and certified for different program versions. As a result, by the combination of high integration with simultaneous low evaluation efforts and high program variability, a substantial improvement of the manufacturing costs with constant high safety is achieved.

For the purpose of the invention, various improvements of structural and/or functional nature can be provided.

Normally, it will be provided that in the safety core a key memory connected with the core processor with at least one cryptographic key stored therein is provided for the decryption and/or encryption of data sets. Then the core processor is adapted for the decryption of imported programs/data sets and for the encryption of exported programs/data sets. This may take place in addition to an authentication/verification.

The core memory preferably is formed as a RAM memory and a flash memory, the RAM memory and the flash memory typically being connected with the core processor by a memory management unit (MMU) and/or a translation lookaside buffer (TLB).

The safety core is provided with means for the detection of unauthorized manipulations, which are connected with the core processor and/or the key memory, the processor and/or the key memory optionally being adapted to delete at least the key memory, if an unauthorized manipulation is detected. These means are well known to the man skilled in the art and need not be explained here in more detail.

The mass storage preferably comprises a non-volatile Random Access Memory (NVRAM) and/or a random access memory (RAM), in particular a mass flash memory.

The core interface and/or the mass storage will typically have an interface, which is (also) adapted for loading programs/data sets from safety module-external data processing devices.

In functional regard, the core processor can be adapted for the execution of the following method steps for the transformation of programs/data sets:

a) a program/data set, preferably authenticated, is loaded into the mass storage,

b) then follows an analysis of sections of the program/data for program code and data, of the data optionally for volatile data, persistent data, compressed data, non-initialized data, initialized data and safety-critical data,

c) partitioning of the sections into pages, for each page a page-individual authentication code being formed with the aid of a key code stored in the key memory and assigned to the respective page, connected with the respective page and additionally stored separately in the core memory in a code table,

d) copying, if applicable after decompression and/or initialization, of the pages connected with the page-individual authentication code into free physical address sectors of the mass storage, and

e) optionally, verification of the program/data set loaded in step a).

The core processor may further be adapted for the execution of the following further method steps:

f) the MMU and/or the TLB are configured such that executing, reading, or writing virtual addresses of a transformed program leads to an exception, an exception being characterized by that the TLB does not have an entry for a virtual address, and that in case of an exception by means of the virtual address and the code table a page to be imported is identified, imported from the mass storage, verified by means of the authentication code, optionally decrypted, and with successful verification stored in the core memory for the program execution, and

g) in the TLB an entry is stored, by means of which an exception for the virtual addresses of the address space of the imported page is prevented.

In the case of no free entries in the TLB, the following method steps can be executed:

h) a page is identified in the core memory, which is not required for the program execution, and

i) the not required page is deleted in the core memory or exported into the mass storage after an authentication.

When importing and/or exporting a page and/or a section, the respective page or section can be provided with a current number index, the current number index being stored in the core memory with an assignment to the page or section. Then it may be provided that when importing again the page or section, the current number index is analyzed and compared with the stored assigned current number index. In case of a positive comparison (identity) then the section or page is deleted. In case of a negative comparison then the page or section is assigned to a new current number index and is stored. Thereby at last it is achieved that no data already imported are re-used when importing again. This is for instance important in the case of safety-critical variable data, which are imported, used and changed during a program execution, such as for instance money value data, since thereby the once again use of old data not being up-to-date anymore is prevented.

Essentially, in particular the following functional features are implemented. It is secured that a program code is executed exclusively in the safety core, i.e. outside of the core memory. Data and conditions are processed exclusively in the safety core, i.e. in the core memory. Program codes, which are imported from the mass storage into the safety core, are authenticated and are verified before the execution. Safety-critical data, which are imported from the mass storage, are normally encrypted and authenticated and are decrypted and verified before use in the safety core. Non-safety-critical data, which are imported from the mass storage, are normally not encrypted, however authenticated and are verified before execution. For this purpose, exclusively in the safety core, the key codes for authenticating, verifying, decrypting and encrypting are generated and administered by the safety processor and the firmware. A generation of such key codes, too, takes place exclusively in the safety core.

The invention further relates to a method for operating a safety module according to the invention with the above functional steps.

The invention also encompasses the use of such a safety module in a franking machine or a computer with a franking function, wherein the method according to the invention is implemented, and wherein the data sets include data for money value balances and spent money values.

### BRIEF DESCRIPTION OF THE DRAWINGS

FIG. 1 is a block diagram of an embodiment of a safety module according to the invention.

FIG. 2 is a flowchart for a transformation of a program/data set entered into the mass storage and to be verified.

FIG. 3 illustrates the execution of the program transformed according to FIG. 2.

### DESCRIPTION OF THE PREFERRED EMBODIMENTS

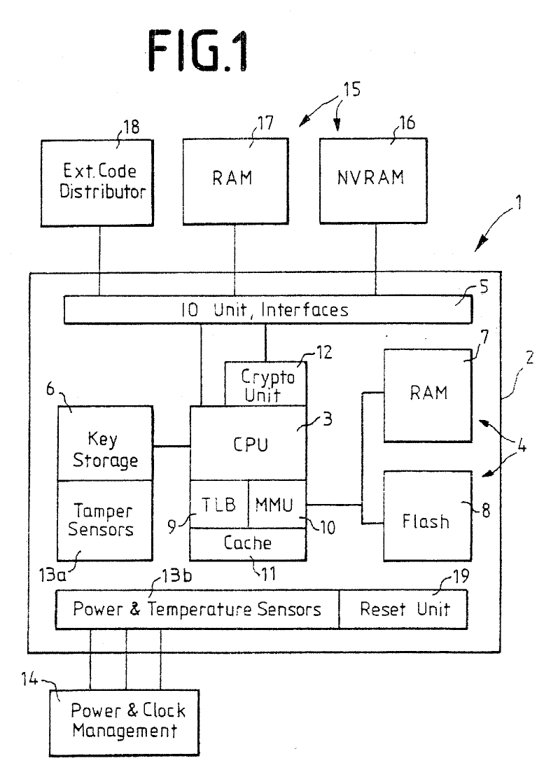

The safety module 1 shown in FIG. 1 includes a safety core 2 with a core processor 3, a core memory 4 and a core interface 5. To the core processor 3 is connected a key memory 6. The core memory 4 includes a RAM memory 7 and a flash memory 8. In the core processor 3 are provided a translation lookaside buffer (TLB) 9, (MMU0 10 and a cache 11, which are connected in a conventional manner with the core memory 4. In the core processor 3 is further provided a unit 12 for the decryption and encryption of programs/data sets. In the safety core 2 are finally provided means 13a, 13b for the detection of unauthorized manipulations. The key memory 6 is provided with an own safety core-internal power supply. If by the means 13a, 13b for the detection of unauthorized manipulations such a manipulation is detected, key codes stored in the key memory 6 are automatically deleted for instance by means of a reset unit 19. Otherwise, the safety core 2 is supplied externally by a power and clock supply 14. Within the safety module 1, however outside of the safety core 2, a mass storage 15 is provided, which is connected with the core interface 5. The mass storage 15 comprises in the example of execution an NVRAM 16 and a RAM 17, in particular a mass flash memory. Via an interface 18 programs/data sets can be loaded from outside, for instance by data remote data transfer, into the mass storage 15 and/or the safety core 2.

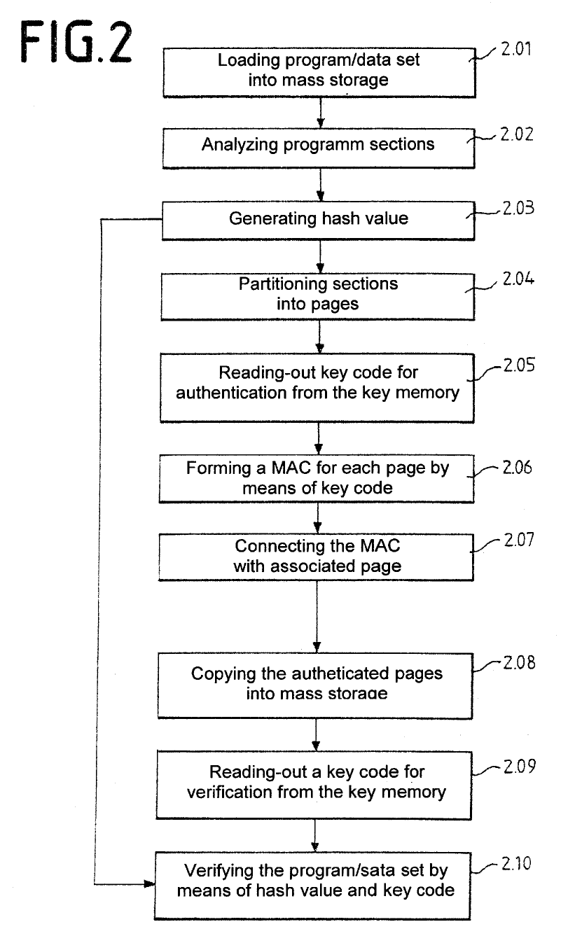

FIG. 2 shows a flowchart for a transformation of a program/data set entered into the mass storage 15 and to be verified. In step 2.01 an externally available program code and data is loaded into the RAM 17 of the mass storage 15. This may be implemented in parallel or sequentially. In step 2.02 the core processor 3 makes an analysis of the sections of the program stored in the RAM 17 for volatile data, persistent data, not initialized data, initialized data, safety-critical data and executable program codes. During the analysis in step 2.03 a hash value is generated from the program/data set in total, which is then used in step 2.10 for the verification of the program/data set. In step 2.04 the sections are partitioned into pages, and after readout of a key code from the key memory 6 in step 2.05 an MAC is formed in step 2.06 by means of this key code for each page. Each MAC is then connected in step 2.07 with its page. In step 2.08 the pages respectively provided with their MAC are stored in the mass storage 4. In step 2.09 a readout of a key code is made for the verification from the key memory 6, whereupon in step 2.10 a verification of the program/data set takes place with this key and the hash value from step 2.03. In case of a negative verification, a deletion of all pages occurs.

With the above transformation a table has been created, the entries of which consisting of the MACs or the respective authentication data of the pages. This table is stored in the core memory 4. An authentication data set can for instance comprise the following elements: MAC (16 bytes), physical address and section options (4 bytes), virtual address and access properties (4 bytes). The total is then 24 bytes. For a program size of 4 MB and a page size of 4 kB results a table size of 1000 (4 MB/4 kB)*24 bytes=24 kB. For optimization of the core memory 4, this table can be stored in the flash memory, since the program code is rarely modified.

For a source data set size of 256 kB results in an analogous manner a table size of 1,536 kB. The table of the data sets normally is relatively small and must however also be updated regularly, since the data may change during the program execution.

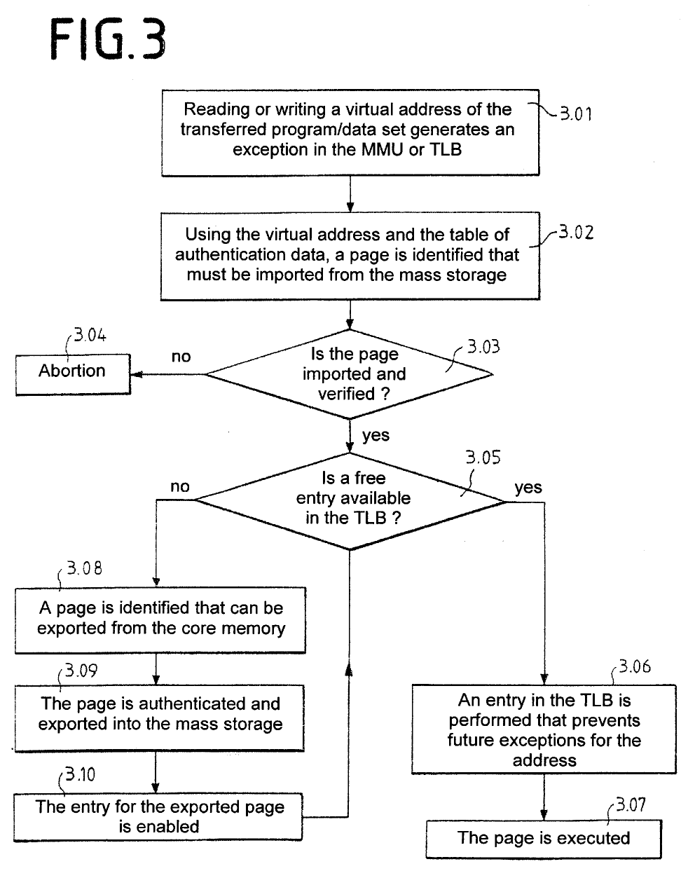

Subsequently to the transformation, as shown in FIG. 3, the import and the execution of the transformed program or of a page occur. First, in step 3.01 an exception is produced in the MMU 10 or TLB 9 by reading or writing a virtual address. For this purpose, the MMU 10 and the TLB are configured correspondingly. Then in step 3.02, with the virtual address and the table explained above with authentication data, the page is searched, which according to the virtual address must be imported for the execution of the program. In step 3.03 the respective page according to the section options of the authentication data is treated and imported, and a verification takes place, if applicable connected with a decryption. If the verification is not successful, then according to step 3.04 an abortion will follow. Otherwise a free entry is searched in the TLB 9 (step 3.05). If there is such one, then in step 3.06 an entry is performed, which will prevent future exceptions for the virtual address. The in step 3.07 the execution of the page occurs. If in step 3.05 no free entry in the TLB 9 is identified, first in step 3.08 a page is identified, which may be exported from the memory, since instantly not required for the execution of the program. In step 3.09 this page is then authenticated and exported into the mass storage 15. The respective entry is then enabled in step 3.10, so that the examination in the TLB in step 3.05 is now positive etc.

For the export of pages, methods can be used that are known from the administration of cache structures. Since exports of pages from the safety core are time-consuming, a write-back strategy of the modified pages is preferred, if the respective data are not persistent. Depending on the section options, the following rules can be applied. Code segments are simply deleted, since an invariant copy is always available in the mass storage 15. Safety-critical data are first exported in an encrypted condition, and their authentication data are updated. For non-safety-relevant variable data, the encryption may be dropped. The import and the export of pages and the update of authentication data occurs in a monolithic manner, i.e. without interrupt possibility, but not as a transaction. Persistent data are in principle explicitly read and written or imported or exported. Modifications take exclusively place on RAM copies.

For the functionality of the safety core 2, it may further be provided that programs/data sets stored in the mass storage 15 stored can be exchanged. For instance a transfer protocol between the safety core and a safety module-external system can be used, which e.g. implements the programming of the external mass storage 15 with firmware. Such routines are known from the documents DE 101 37 505 B4 and DE 10 2004 063 812 A1.

It is possible to initialize and continuously reset a watchdog timer from the safety core 2, so that in the case of a fault of the hardware or firmware the safety module 1 is transferred into a defined fault condition, e.g. reset of the hardware and signalization of the condition. The functions for the fault signalization (e.g. optically by LEDs or the like) are also implemented in the safety core. Faults are e.g.: there exists no address translation for a referenced virtual address, writing is to be performed on a page with write protection (for instance since it is a program code segment), or a cryptographic key code is not present.

Although modifications and changes may be suggested by those skilled in the art, it is the intention of the inventors to embody within the patent warranted hereon all changes and modifications as reasonably and properly come within the scope of their contribution to the art.

We claim as our invention:

1. A safety module for electronic data processing, comprising:
a safety core comprising a core processor, and connected therewith, a core memory and a core interface, said core memory having a memory capacity;
the core processor being configured to import via the core interface, and to verify and with successful verification to store and to activate programs/data sets in the core memory;
that the safety core being connected by the core interface with a mass storage of the safety module arranged outside of the safety core, the mass storage having a memory capacity that is a multiple of the memory capacity of the core memory,
the core processor being confused to import, verify and activate programs/data sets loaded into the mass storage for a program execution in a partitioned manner in the core memory; and
the core processor being configured to authenticate partitioned programs/data sets not required for the program execution and stored in the core memory and to export said partitioned programs/data sets into the mass storage and/or to delete said portioned programs/data sets, in the core memory.

2. A safety module according to claim 1, wherein the safety core comprises a key memory connected with the core processor and having at least one cryptographic key stored therein for decryption and/or encryption of data sets.

3. A safety module according to claim 2, wherein the core processor is configures for the decryption of imported programs/data sets and for the encryption of exported programs/data sets

4. A safety module according to claim 1, wherein the core memory comprises a RAM memory and a flash memory.

5. A safety module according to claim 4, wherein the RAM memory and the flash memory are connected with the core processor by a memory management unit (MMU) and/or a translation lookaside buffer (TLB).

6. A safety module according to claim 1, comprising core protection that detects unauthorized manipulations of the safety core, said core protection being connected with the core processor and/or the key memory.

7. A safety module according to claim 6 wherein said core processor is configured to delete at least key codes stored in said key memory if an unauthorized manipulation is detected.

8. A safety module according to claim 1, wherein the mass storage comprises a non-volatile random access memory and/or a random access memory.

9. A safety module according to claim 1, wherein the core interface and/or the mass storages have an interface, configured for loading programs/data sets from safety module-external data processing devices.

10. A safety module according to claim 1, wherein the core processor configured for execution of the following method steps for the transformation of programs/data sets:
a) a program/data set is loaded into the mass storage;
b) then follows an analysis of sections of the program/data sets for program code and data, of the data optionally for volatile data, persistent data, compressed data, non-initialized data, initialized data and safety-critical data;
c) partitioning of the sections into pages, for each page a page-individual authentication code being formed using a key code stored in the key memory and assigned to the respective page, connected with the respective page and additionally stored separately in the core memory in a code table;
d) copying, if applicable after decompression and/or initialization, of the pages connected with the page-individual authentication code into free physical address sectors of the mass storage.

11. A safety module according to claim 10, wherein said core processor is configured for verification of the program/data set loaded in step a).

12. A safety module according to claim 10, wherein the core processor is configured for the execution of the following further method steps:
a memory management unit and/or a translation lookaside buffer (TLB) are configured such that executing, reading, or writing virtual addresses of a transformed program leads to an exception, an exception being characterized by that the TLB does not have an entry for a virtual address, and that in case of an exception by means of the virtual address and the code table a page to be imported is identified, imported from the mass storage, verified by the authentication code, and with successful verification stored in the core memory for the program execution; and
in the TLB an entry is stored, by means of which an exception for the virtual addresses of the address space of the imported page is prevented.

13. A safety module according to claim 12, wherein the core processor in the case of no free entries in the TLB, Is configured to execute the following method steps:
a page is identified in the core memory, which is not required for the program execution, and
the not required page is deleted in the core memory or exported into the mass storage after an authentication.

14. A method for operating a safety module (1) according to one of claims comprising the steps of:
a) loading a program/data set into a mass storage;
b) electronically analyzing sections of the program/data for program code and data, of the data optionally for volatile data, persistent data, compressed data, non-initialized data, initialized data and safety-critical data;
c) partitioning the sections into pages, for each page a page-individual authentication code being formed using a key code stored in the key memory and assigned to the respective page, connected with the respective page and additionally stored separately in the core memory in a code table; and
d) copying, if applicable after decompression and/or initialization, of the pages connected with the page-individual authentication code into free physical address sectors of the mass storage.

15. The method according to claim 14 comprising verifying the program/data set loaded in step a).

16. The method according to claim 14 comprising the following further method steps:
confirming a memory management unit and/or translation lookaside buffer (TLB) such that executing, reading, or writing virtual addresses of a transformed program leads to an exception, an exception being characterized by that the TLB (9) does not have an entry for a virtual address, and that in case of an exception by means of the virtual address and the code table a page to be imported is identified, imported from the mass storage (15), verified by means of the authentication code, optionally decrypted, and with successful verification stored in the core memory (4) for the program execution, and
storing an entry in the TLB that prevents an exception for the virtual addresses of the address space of the imported page.

17. The method according to claim 16, wherein in the case of no free entries in the TLB, the following method steps are executed:
a page is identified in the core memory, which is not required for the program execution; and
not required page is deleted in the core memory or exported into the mass storage after an authentication, optionally an encryption.
